(19) United States
(12) Patent Application Publication
(10) Pub. No.: US 2008/0035174 A1
(43) Pub. Date: Feb. 14, 2008

(54) SOLUBLE FOAMING ARTICLE

(75) Inventors: Odile AUBRUN-SONNEVILLE, Antony (FR); Dominique Bordeaux, Thiais (FR)

Correspondence Address: OBLON, SPIVAK, MCCLELLAND MAIER & NEUSTADT, P.C., 1940 DUKE STREET, ALEXANDRIA, VA, 22314, US

(73) Assignee: L'OREAL, Paris (FR)

(21) Appl. No.: 11/567,319

(22) Filed: Dec. 6, 2006

Related U.S. Application Data
(60) Provisional application No. 60/752,006, filed on Dec. 21, 2005.

(30) Foreign Application Priority Data
Dec. 7, 2005 (FR) 05 53751

(51) Int. Cl. B08B 7/04; B32B 3/26; B32B 5/26; B32B 9/04

(52) U.S. Cl. 134/18; 428/305.5; 428/704; 442/381; 442/414

(57) ABSTRACT

An article, containing:
a support in the form of at least one sheet containing fibres that are water-soluble at a temperature of 0-30° C., and
a composition carried by the support, containing at least one foaming surfactant chosen from acylamino acid compounds.

### REFERENCE TO PRIOR APPLICATIONS

This application claims priority to U.S. provisional application 60/752,006 filed Dec. 21, 2005, and to French patent application 0553751 filed Dec. 7, 2005, both incorporated herein by reference.

### FIELD OF THE INVENTION

The present invention relates to a soluble foaming article comprising a water-soluble support and at least one acylamino acid-based surfactant, and to the use of said article for, e.g., cleansing the skin and/or the hair and/or removing makeup from the skin and/or as an exfoliating product for the skin. The article is partially or completely water-soluble.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

Foaming products are generally difficult to protect from a microbiological point of view since the surfactants have a tendency to inhibit the activity of certain antimicrobial agents. For this reason, it may be advantageous to have anhydrous foaming products which contain no or very little water, thereby making it possible to avoid microbiological problems. Glycol-rich products constitute a possible solution for overcoming this problem. However, the cosmetic qualities of these products are often mediocre since the presence of glycols gives the textile a tacky effect and inhibits foam development.

Another solution consists in using products in powdered form. However, these products are not practical to use since it is difficult to meter the amount to be used. Moreover, the volatility of certain powders can cause nose and throat irritation problems. Finally, these powdered products, if they are presented as such, take one back to the world of washing powders, which can create a negative preconception in the minds of cosmetic product consumers.

Moreover, document WO-A-2005/060931 describes soluble films containing foaming surfactants; they are cleansing wipes obtained from film-forming polymers and from cleansing agents. These cleansing wipes are obtained by solubilizing the polymer in water, and then by applying the gel that has formed in a thin layer on a support so as to dry it and to form a thin film. The cleansing agent is then applied to the film by various possible techniques. The cleansing wipe obtained solubilizes in less than 2 minutes upon contact with water. However, this technology imposes quite a considerable limitation on the amount of cleansing agent that can be used (a maximum of 30%) compared with the amount of polymer, which is largely abundant since it most commonly represents from 70 to 99% of the thin film obtained, which limits the operating qualities of the product, in particular its foaming capacity.

### SUMARY OF THE INVENTION

There remains therefore the need for foaming compositions that do not have the drawbacks of those of the prior art, and in particular that show good storage properties in microbiological terms while at the same time being easy and pleasant to use, without having a tacky effect, and that contain sufficient foaming surfactant to have a good foaming effect, while at the same time showing good foam development.

The present invention satisfies this need. Specifically, the inventors have found, surprisingly, that the use of specific pulverulent foaming surfactants in a water-soluble carrier provides foaming products that are generally in the form of ready-to-use single doses, and that have good cosmetic qualities and good foaming properties. These specific surfactants, which are acylamino acids or acylamino acid derivatives, make it possible to obtain cleansing articles that solubilize readily in water, giving a milk that is pleasant to use, whereas other surfactants solubilize poorly, or else they solubilize well but give sticky or agglomerated pastes that are relatively unpleasant to use. Alone, the acylamino acids and derivatives thereof make it possible to achieve the aim of the invention by making it possible to obtain a soluble article which foams well and is pleasant to use.

### DESCRIPTION OF THE PREFERRED EMBODIMENTS

Thus, according to one of its aspects, the invention lies in an article for topical application, in particular cosmetic or dermatological, comprising:

a support in the form of at least one sheet comprising fibres that are water-soluble at a temperature less than or equal to 30° C., and

a composition carried by the support, comprising at least one foaming surfactant chosen from acylamino acids and derivatives thereof.

The expression “cosmetic or dermatological article” means a cosmetic or dermatological product comprising a solid support including a composition carried by this support.

According to one specific embodiment, an article comprising a composition containing 50% by weight of sodium laureth sulphate at 70% in water (Texapon N702 from Cognis), 24.9% by weight of disodium cocoamphodiacetate at 39% in brine water (11% sodium chloride) (Miranol C2M from Rhodia), 16.9% by weight of sodium lauroyl sarcosinate at 90% in water (Sarkosyl NL97 from Ciba Geigy), 3% by weight of fragrance, 5% by weight of glycerol and 0.3% by weight of preserving agents is excluded from the invention.

In the present application, the expression “carried by the support” means that the composition may be either placed on the support or introduced into the cavity formed by the support when the latter comprises at least two, e.g., sheets or layers forming a cavity. Of course, both situations may occur in the same article depending on the extent of overlap of the at least two supports. “On the support” includes composition located in interstices of the support.

Moreover, the expression “a composition comprising at least one foaming surfactant chosen from acylamino acids and derivatives thereof” means a composition which may consist only of one or more foaming surfactants chosen from acylamino acids and derivatives thereof, or alternatively a composition comprising at least one foaming surfactant chosen from acylamino acids and derivatives thereof, and one or more other compounds. Thus, the acylamino acid(s) and/or acylamino acid derivative(s) may constitute the only compounds of the composition carried by the support.

The expression “temperature less than or equal to 30° C.” means a temperature that does not exceed 30° C. but is not less than 0° C., e.g., 0-30° C., for example ranging from more than 0° C. to 30° C., better still from 5° C. to 30° C., and even better still from 10° C. to 30° C., including 15, 20 and 25° C., and all ranges and subranges therebetween.

This article is preferably in the form of single doses, which offers the following advantages:
the product is practical to use,
the product can be readily carried on one's person or on a journey without fear of spilling it or having it run,
the product is free of preserving agent,
the product can be entirely water-soluble, which limits the amount of waste and is therefore good for the environment.

The terms “sheet” and “layer” are synonyms in the present application. The support of the present invention is preferably in the form of one or more sheets of fibres, which is different from water-soluble thin films which are not in the form of sheets of fibres. Compared with these water-soluble thin films, the supports based on water-soluble fibre sheets according to the invention have the advantage of allowing the incorporation of incompatible constituents, and being simpler to use since they do not require any premixing or solubilization of the components, nor heating to evaporate off the solvent, the process also being more rapid and less expensive. In addition, the supports according to the invention have the advantage of allowing a greater diversity in the choice of the shape and the appearance of the article since the fibre sheet can vary in thickness and density providing the opportunity for a great variety of size and shape, whereas the thin film is difficult to dry if it is too thick, and it is fragile and difficult to handle if the size is too great.

According to a preferred embodiment of the invention, the article is in the form of at least two sheets that together define a cavity, at least one of the sheets comprising fibres that are water-soluble at a temperature less than or equal to 30° C.,
the cavity containing a composition containing at least one foaming surfactant chosen from acylamino acids and derivatives thereof.

The sheets are assembled at their periphery and thus form a cavity for introducing the composition containing the foaming surfactant(s) used according to the invention.

The sheets can be formed entirely of water-soluble fibres or else one of the sheets can consist entirely of water-soluble fibres and the other sheet can consist of insoluble fibres or of both water-soluble fibres and water-insoluble fibres, or else the two sheets can consist of both soluble fibres and insoluble fibres.

According to a preferred embodiment, at least one of the sheets consists exclusively of water-soluble fibres.

A foaming composition for topical application, in particular a cosmetic or dermatological composition, that can be used for cleansing the skin or the hair, is obtained by moistening or dissolving the The article according to the invention in water or in an aqueous composition such as a lotion. If the support comprises only soluble fibres, it will be completely dissolved in the water, and if it comprises soluble fibres and insoluble fibres, the latter will remain in solid form after solubilization of the article, and the article may then, for example, constitute a mild scrub. When the article is dissolved in a lotion, the latter may optionally contain active agents which will therefore be mixed with the constituents of the article at the time the latter is dissolved.

Thus, a subject of the invention, according to another of its aspects, is also a composition for topical application, obtained by dissolving, in water, an article as defined above, i.e. a composition obtained by dissolving, in water, a support in the form of at least one sheet comprising fibres that are water-soluble at a temperature less than or equal to 30° C., said support carrying a composition containing at least one foaming surfactant chosen from acylamino acids and derivatives thereof.

The temperature for dissolving the article in water is generally ambient temperature (20 to 30° C.), but may be above ambient temperature if desired, depending on the use envisaged.

A subject of the invention, according to another of its aspects, is also a cosmetic process for cleansing a keratin material such as the skin, the hair or the mucous membranes, and in particular a cosmetic process for cleansing the skin, comprising:
the formation of a cosmetic composition by dissolving, in water, a support comprising at least one sheet comprising fibres that are water-soluble at a temperature less than or equal to 30° C., and carrying at least one foaming surfactant chosen from acylamino acids and derivatives thereof,
the application of the composition thus formed to the keratin material.

The cleansing includes removing makeup from the skin.

The expression “dissolving in water at a temperature less than or equal to 30° C.” should be understood to mean solubilization in water at a temperature ranging up to 30° C. with the aid of manual agitation and/or friction of the support, where appropriate, for a period of time typically less than 5 min, preferably less than 1 min, preferably less than 30 seconds. The invention does not exclude water at a temperature above 30° C. being used to dissolve the support.

Since the The article according to the invention is intended for topical application, it preferably comprises a physiologically acceptable medium. The term “physiologically acceptable medium” is intended to mean a medium compatible with keratin materials such as the skin, the lips, the nails, the scalp and/or the hair. The same is true of the support, and also of the composition carried by the support.

The The article according to the invention preferably does not contain any adhesive, but it can adhere to the skin when it is moistened.

In addition, this article is preferably flexible, i.e. supple. The term “supple” should be understood to mean an article that can be compressed or that can bend without breaking, and that can adjust to the contours of the human body. A supple article produced in the form of a fibrous sheet can, in certain examples of implementation, be folded over at least once without breaking into two pieces.

This article is generally preferably a single-use article.

Moreover, the article is generally preferably dry to the touch before use.

After the article has been manufactured, it can, for example, be packaged in bulk in a box, or in an individual packaging. Where appropriate, the articles are packaged as a string. The articles can also be folded over on themselves and intercalated, such that the withdrawal of an article brings the next one into a configuration that facilitates it being gripped.

Thus, a subject of the invention, according to another of its aspects, is also an assembly comprising:
a packaging,
at least one article as defined above.

The invention thus offers new possibilities for the packaging and the formulation of foaming cosmetic products.

In an example of implementation of the invention, the article is rapidly run under water and is then placed in the hollow of the hand for a few seconds (for example 5 seconds) and it is then massaged so as to develop the foam, if necessary adding water in small amounts so as to increase the foam volume. Next, the foam is applied to the skin, for example the facial skin which may or may not have been moistened beforehand, and the skin is cleansed by massaging, rinsed with clear water, and then dried.

Instead of using water, it is possible to use an aqueous cosmetic composition for hydrating the article; it can also be rehydrated with an aqueous composition, i.e. a composition containing at least 50% by weight of water relative to the total weight of the composition, it being possible for this composition to be in the form of a lotion, a milk, a cream or a gel.

### Support

The support is preferably in the form of a sheet comprising water-soluble fibres, i.e. fibres that are water-soluble at a temperature less than or equal to 30° C., preferably water-soluble at a temperature less than or equal to 20° C., i.e. having a temperature for dissolution in water ranging from more than 0° C. to 30° C., preferably from more than 0° C. to 20° C., and for example from 5° C. to 30° C., and better still from 5 to 20° C.

The support may be substantially non-retractable once wet.

The support may have any shape, including any shape suitable for the intended use, for example a rectangular, round or oval shape, and it preferably has dimensions that allow it to be gripped between at least two fingers. Thus, the support may have, for example, an ovoid shape approximately 2 to 10 cm long and approximately 0.5 to 4 cm wide, or a disc shape approximately 2 to 10 cm in diameter, or a square shape, the length of the sides being approximately 5 to 15 cm, or a rectangular shape approximately 5 to 15 cm long, it being understood that it may have any other shape and size suitable for the desired use.

The support may form, for example, a cushion, a mask, a patch, a haircap, a fingerstall or glove, a sheet to be cut to size, a cleansing wipe, a disc, an oval or a rectangle. In addition, the support may be in a form which depends on the region of the body to be cleansed.

The support may have a flattened shape or a non-flattened shape, having, for example, the appearance of a block formed from a globular clump of compacted water-soluble fibres, incorporating a composition containing the surfactants used according to the invention.

The fibres of the support are preferably generally entangled so as to form the sheet of fibres. As indicated above, the expression “sheet comprising water-soluble fibres” is intended to mean a sheet that may consist entirely of water-soluble fibres or a sheet that may comprise both water-soluble fibres and water-insoluble fibres, there having to be more soluble fibres than insoluble fibres. The sheet of fibres must comprise at least 60% by weight of soluble fibres, preferably at least 70%, and better still at least 80% by weight relative to the total weight of the fibres of the support. It can thus comprise, for example, more than 95% by weight, or even more than 99% by weight and even 100% by weight of water-soluble fibres relative to the total weight of the fibres of the support. Thus, the support may consist entirely of sheets of soluble fibres or it may consist of sheets comprising a mixture of soluble fibres and insoluble fibres, the insoluble fibres being, according to the definition of the present invention, fibres which are not water-soluble at a temperature less than or equal to 30° C. The fact of having insoluble fibres may make it possible to have a foaming product that at the same time is a scrub product, the insoluble fibres constituting the exfoliating compound.

Thus, the support can be formed from two sheets consisting of water-soluble fibres, or else from a sheet consisting of water-soluble fibres and a sheet comprising both soluble fibres and insoluble fibres, or alternatively also from a sheet consisting of water-soluble fibres and a sheet consisting of water-insoluble fibres, or else from two sheets comprising both soluble fibres and insoluble fibres. There may also be more than two sheets.

According to a preferred embodiment of the invention, the support is free of water-insoluble fibres and it is composed only of water-soluble fibres, such that it is entirely water-soluble.

The soluble fibres may be made of any soluble material that can be spun into fibres. Preferably, the water-soluble fibres are produced with polyvinyl alcohol (PVA) according to a process which gives them the desired solubility, it being possible for the PVA to have several degrees of polymerization.

PVA fibres that are water-soluble at a temperature less than or equal to 30° C. are marketed by the Japanese company Kuraray under the trade name Kuralon K-II WN2. The process for manufacturing these fibres comprises the preparation of a solution to be spun, by dissolution of a water-soluble PVA-based polymer in a first organic solvent, the spinning of the solution in a second organic solvent so as to obtain solidified filaments, and the wet drawing out of the filaments, from which the first solvent is removed, and which are then dried and subjected to a thermal treatment. The cross section of these fibres may be substantially circular. These fibres have a tensile strength of at least 2.7 g/dtex (3 g/d). Application EP-A-0 636 716 describes such PVA-based water-soluble fibres and the process for the manufacture thereof.

The invention is not limited to the use of PVA, and fibres made of other water-soluble materials can also be used, with the proviso that these materials dissolve in water having the desired temperature, for example polysaccharide fibres marketed under the name Lysorb by the company Lysac Technologies, Inc, or polyholoside polymer-based fibres such as glucomannan or starch.

The sheet of fibres can, where appropriate, comprise a mixture of various fibres that are water-soluble at different temperatures (up to 30° C.).

The fibres may be composites, and they may, for example, comprise a core and a sheath that are not of the same nature, for example formed from various grades of PVA.

When the sheet of fibres contains insoluble fibres, the latter can be made of any insoluble fibres; this may be, for example, fibres made from silk, cotton, wool, flax, cellulose extracted in particular from wood, vegetables or algae, polyamide (Nylon®), polylactic acid, modified cellulose (rayon, viscose, acetate, in particular rayon acetate), poly-p-phenylene-terephthalamide, in particular Kevlar®, acrylic, in particular poly(methyl methacrylate) or poly(2-hydroxyethyl methacrylate), polyolefin, and in particular polyethylene or polypropylene, glass, silica, aramide, carbon, in particular in graphite form, Teflon®, insoluble collagen, polyesters, polyvinyl chloride or polyvinylidene chloride, polyvinyl alcohol, polyacrylonitrile, chitosan, polyurethane, polyethyleneterephthalate, fibres formed from a mixture of the compounds mentioned above, such as polyamide/polyester fibres or viscose/polyester fibres. Nonwovens are described, in general, in Riedel “Nonwoven Bonding Methods & Materials”, Nonwoven World (1987), incorporated herein by way of reference.

In a specific example of implementation of the invention, the support sheet is a nonwoven comprising water-soluble fibres, alone or as a mixture with insoluble fibres as indicated above, with at most 40% by weight of insoluble fibres relative to the total weight of the fibres of the support. Preferably, the nonwoven consists of water-soluble fibres, i.e. it does not contain insoluble fibres.

Moreover, the support may also comprise at least one layer of a water-insoluble substrate, i.e. a substrate comprising only insoluble fibres, and in this example of implementation, the support comprises a sheet of a nonwoven consisting of fibres that are water-soluble at a temperature less than or equal to 30° C., and a sheet of a nonwoven consisting of water-insoluble fibres.

When the support comprises only one sheet of fibres, the composition containing the acylamino acid-based surfactant(s) can be deposited on the two faces of the support or on a single face, it being possible for the other face of the support to then be used, for example, for gripping the article.

When the support according to the present invention comprises two sheets, they may in particular be two sheets of nonwoven, it being possible for all the embodiments described below to be used, it being possible for the sheets to contain or not contain insoluble fibres, and it even being possible for one of the sheets to consist only of insoluble fibres, provided that the other sheet contains soluble fibres.

According to a specific embodiment of the invention, each of the sheets is a nonwoven consisting of fibres that are soluble at a temperature less than or equal to 30° C., i.e. the sheets contain only water-soluble fibres.

According to another embodiment, one of the sheets is entirely water-soluble and is a nonwoven consisting of fibres that are soluble at a temperature less than or equal to 30° C., and the other sheet is insoluble and is a nonwoven consisting of insoluble fibres.

According to yet another embodiment, the support comprises two sheets containing soluble or partially soluble fibres with at most 40% of insoluble fibres, and, in addition, a sheet consisting of insoluble fibres, constituting an insoluble substrate. Thus, the support may comprise at least one layer of a water-insoluble substrate, i.e. a substrate comprising only insoluble fibres. In a specific example of this embodiment, the support comprises a soluble sheet of a nonwoven consisting of fibres that are water-soluble at a temperature less than or equal to 30° C., and an insoluble sheet of a nonwoven consisting of water-insoluble fibres.

A multilayer structure with at least one layer formed from a water-insoluble substrate can, for example, be of use for producing an article comprising a support in the shape of a fingerstall. The layer formed from water-soluble fibres is located on the outside of the article, intended to solubilize during use, after having been moistened or upon coming into contact with a moistened region of the body.

All the appropriate techniques for constituting a nonwoven from fibres can be used to manufacture the sheets made of nonwoven, regardless of whether they are soluble or insoluble. For example, the fibres can be formed by extrusion and deposited on a conveyor to form a sheet of fibres which is then consolidated by means of a standard fibre bonding technique, for instance needle bonding, hot-bonding, calendering or air-through bonding, in which technique the sheet passes through a tunnel in which hot air is blown. The latter technique is advantageously used when the sheet consists of two-component fibres, for example fibres comprising at least two grades of polyvinyl alcohol (PVA), the melting points or softening points of which are different, these fibres being, for example, co-extruded such that the fibre consists of at least a first grade located at the core of the fibre and of at least a second grade located at the periphery of the fibre, in the form of a sheath. The bonding of the fibres may be facilitated when the sheath has a melting point lower than that of the core.

The sheet of fibres may also be formed by carding fibres cut to a length of 10 to 50 mm, followed by deposition of the fibres on a conveyor where the sheet may then be consolidated by means of a bonding technique as described above.

When the support comprises several layers, regardless of whether or not all of the latter are made of water-soluble fibres, the various layers can be assembled in many ways, for example by seeding, bonding or sewing, and these layers can, where appropriate, consist of one or more cavities containing one or more cosmetic or dermatological compositions or several components of the same cosmetic composition to be mixed extemporaneously. When assembly is by sewing, a thread which is itself water-soluble may be used, where appropriate.

When the support comprises several sheets of nonwoven, the latter may be assembled in particular by heat-sealing at their periphery so as to constitute a cushion capable of retaining, in an inner cavity, a composition containing at least one acylamino acid-derived foaming surfactant.

According to another aspect of the invention, the support is free of adhesive, in particular of pressure-sensitive adhesive.

The density of the support may depend on the applications. The support may, for example, have a density of less than or equal to 0.1 g/cm³ or else greater than 0.1 g/cm³. According to a preferred embodiment of the invention, the support has a density of less than or equal to 0.1 g/cm³, better still ranging from 0.01 g/cm³ to 0.1 g/cm³, which makes it possible to have a very aerated support which, as a result, dissolves more readily in water.

The composition carried by the support represents between 10 and 1000% by weight, and better still between 10 and 500% by weight, relative to the total weight of the support, the expression “weight of the support” here being intended to mean the weight of the support alone, without the weight of the composition. If the composition contains only the acylamino acids and derivatives thereof, it is these compounds which can represent between 10 and 1000% by weight relative to the total weight of the support, and preferably between 10 and 500% by weight relative to the weight of the support.

### Acylamino Acid Surfactants

The composition containing the foaming surfactants may comprise only the foaming surfactant(s) based on acylamino acids or derivatives thereof, or else it may comprise these surfactants as a mixture with other compounds, for example other foaming surfactants and additives.

The The article according to the invention contains one or more foaming surfactants chosen from acylamino acids and derivatives thereof. These surfactants are in particular chosen from alkali metal salts of N-acyl-amino acids. As alkali metal salts of acylamino acids, mention may be in particular be made of acylalaninate salts, acylglutamate salts, acylaspartate salts, acylglycinate salts and acylsarcosinate salts, and mixtures thereof. These invention acylamino acids and derivatives thereof are sometimes referred to herein as “acylamino acid compounds.”

The preferred surfactants are those in powdered form, such as, for example, the sodium lauroyl glutamate sold under the name Amisoft LS 11 by the company Ajinomoto; the monosodium myristoyl glutamate sold under the name Acylgutamate MS 11 by the company Ajinomoto; the lauroyl methyl beta-alanine (acid form) sold under the name LMA-H by the company Mitsui Toatsu; the N-lauroyl-N-hydroxyethyl-beta-alanine sold under the name LHEA by the company Mitsui Toatsu; and the sodium cocoyl glycinate sold under the name Amilite GCS-11(F) by the company Ajinomoto.

Particularly preferably, the acylamino acids and derivatives thereof are chosen from acylglutamates such as sodium lauroyl glutamate and sodium myristoyl glutamate, and acylglycinates such as sodium cocoyl glycinate, and mixtures thereof.

According to a specific embodiment, the acylamino acid surfactant is not lauroyl sarcosinate in a composition containing 50% by weight of sodium laureth sulphate at 70% in water (Texapon N702 from Cognis), 24.9% by weight of disodium cocoamphodiacetate at 39% in brine water (11% sodium chloride) (Miranol C2M from Rhodia), 16.9% by weight of sodium lauroyl sarcosinate at 90% in water (Sarkosyl NL97 from Ciba Geigy), 3% by weight of fragrance, 5% by weight of glycerol and 0.3% by weight of preserving agents.

The foaming surfactants used according to the invention can be placed on the support as they are, or can be mixed with other compounds.

The acylamino acid(s) and derivatives thereof can represent 100% of the composition carried by the support. They may be present in an amount ranging, for example, from 2 to 100%, and better still from 10 to 100% of the total weight of the composition carried by the support, and preferably from 20 to 100% by weight relative to the total weight of the composition carried by the support. In the application, the expression “% by weight relative to the total weight of the composition” is intended to mean the percentage by weight relative to the total weight of the composition carried by the support (and not relative to the weight of the article comprising support and composition).

### Compositions

The compositions containing the acylamino acid-based foaming surfactant(s) are anhydrous compositions. They are preferably in pulverulent or pasty form, and more preferably in pulverulent form. They are compositions suitable for topical application, in particular cosmetic or dermatological compositions.

Thus, the compositions that can be used in the invention may, for example, be lyophilized or atomized emulsions, such as those described in document FR-A-2,727,312 or those based on modified starch, described in documents EP-A-0 938 892 and EP-A-0 925 777. These emulsions are obtained by lyophilizing or atomizing an O/W emulsion containing a pulverulent phase, producing milks or creams by mixing with water when they are used.

They can also be obtained by simple mixing of the constituents, the latter preferably being in powdered form.

The composition may contain only the acylamino acid-based foaming surfactants, which then represent 100% of the weight of the composition.

Depending on the constituents of the compositions used, the article converts into a foam, or into a foaming milk or a foaming cream.

The composition may optionally contain a certain amount of water at the time it is impregnated onto the support. However, so as to avoid premature solubilization thereof, the water introduced onto the support during its impregnation is very preferably removed, for instance heating. However, the composition may contain a certain amount of water, which is generally bound water and which may come in particular from the hygroscopic starting materials that contain water, such as starches. The final amount of water in the composition present on the article is a maximum of 20% by weight, and preferably a maximum of 10% by weight relative to the total weight of the composition.

When the composition is intended to be deposited on the support by the user himself or herself, the composition and the support can be provided together, in the form of a kit, for example. The composition is, for example, provided in sufficient amount for it to be possible to distribute a plurality of doses thereof on a set of supports intended to be used successively.

### Other Ingredients

The composition contained in the support may contain, in addition to the acylamino acid-based foaming surfactants, other ingredients, in particular other foaming surfactants and additives that are usual in the cosmetics field, such as exfoliants, polymers, oils or particles such as kaolin. These other ingredients are preferably in pulverulent or pasty form, and they are in particular surfactants that are in pulverulent or pasty form, but, if necessary, the additives may be encapsulated or adsorbed onto powders.

### Other Foaming Surfactants

As foaming surfactants other than the acylamino acids and derivatives thereof, use may be made of those normally used in the cosmetics field, it being possible for these surfactants to be anionic, nonionic, cationic, amphoteric or zwitterionic.

The total amount of foaming surfactant(s) including the acylamino acids and derivatives thereof may range, for example, from 2 to 100% by weight, preferably from 10 to 100% by weight relative to the total weight of the composition carried by the support.

As foaming anionic surfactant, mention may be made of fatty acid salts that constitute soaps and that are derived from a fatty acid having an alkyl chain containing from 6 to 22 carbon atoms, preferably from 8 to 18 carbon atoms, it being possible for the neutralizing agent to be an organic or inorganic base such as potassium hydroxide, sodium hydroxide, triethanolamine, N-methylglucamine, lysine and arginine; alkyl sulphates and alkyl ether sulphates; sulphonates, and mixtures thereof.

As nonionic surfactants, mention may, for example, be made of sugar esters, sugar ethers such as alkyl polyglucosides (APGs), condensates of alkylene oxides and of alkylphenols, ethers of a fatty alcohol and of polyols, and mixtures thereof.

As amphoteric or zwitterionic surfactants, mention may be made of betaines and derivatives thereof, sultaines and derivatives thereof, imidazolinium derivatives, and mixtures thereof.

The preferred surfactants are those in powdered form, such as, for example, sodium lauryl sulphate, for instance the product sold under the name Empicol LZ D by the company Allbright & Wilson or under the name Tensopol USP97 by the company Tensachem; cocamido-propylbetaine, for instance the product sold under the name Tegobetain CK D by the company Degussa; the mixture of sodium laureth sulphate and silica, sold under the name Texapon KE 2713 by the company Cognis; disodium cocamido MEA-sulphosuccinate, for instance the product sold under the name Mackanate CM 100 by the company MacIntyre; sodium methyl cocoyl taurate, for instance the product sold under the name Tauranol WSP by the company Finetex; sodium decyl d-galactoside uronate, for instance the product sold under the name Decyl d-galactoside uronate de sodium by the company Ard-Soliance; sodium cocyl isethionate, for instance the product sold under the name Jordapon CI P by the company BASF; sodium lauryl sulphoacetate, for instance the product sold under the name Lathanol LAL poudre [powder] by the company Stepan; potassium myristate, for instance the product sold under the name Myristate de potassium (DUB MK) by the company Stearinerie Dubois; potassium laurate, for instance the product sold under the name Laurate de potassium (DUB LK) by the company Stearinerie Dubois, and sucrose laurate, for instance the product sold under the name Grilloten LSE 87 by the company Degussa.

### Polymers

The composition carried by the support can also contain one or more polymers, in particular water-soluble polymers. By way of example of water-soluble polymers that can be used in the invention, mention may be made of gums such as guar gum, xanthan gum, carrageenum gum, sclerotium gum, konjac gum, gum tragacanth, and derivatives of these gums; cellulose derivatives such as hydroxyalkylcelluloses, carboxymethylcellulose; starch derivatives such as the hydroxypropyl starch phosphate sold under the name Strucure XL by the company National Starch (INCI name: Hydroxypropyl Starch Phosphate); pectins; polyacrylamides and acrylamide copolymers, and in particular 2-acrylamido-2-methylpropanesulphonic acid homopolymers and copolymers such as those sold under the names Hostacerin AMPS and Aristoflex by the company Clariant, gelatine, agar-agar, carboxyvinyl polymers such as the products sold under the name Carbopol by the company Noveon (CTFA name: carbomer), modified carboxyvinyl polymers, and in particular acrylate/C₁₀-C₃₀-alkyl acrylate copolymers such as the products sold under the names Pemulen TR1 or TR2 or Carbopol 1382 by the company Noveon (CTFA name: Acrylates/C10-30 Alkyl Acrylate Crosspolymer), montmorillonite and magnesium aluminium silicate.

When they are present, the amount of polymer(s) in the composition of the invention can range, for example, from 0.1 to 30%, and preferably from 0.5 to 20% of the total weight of the composition carried by the support.

### Exfoliants

The composition may also contain exfoliants, in particular for constituting an exfoliating composition or a facial scrub or body scrub. As exfoliants, mention may, for example, be made of exfoliating or scrubbing particles of inorganic, plant or organic origin. Thus, use may, for example, be made of polyethylene beads or powder, nylon powder, polyvinyl chloride powder, pumice stone, ground apricot kernels or nutshells, sawdust, glass beads, alumina, and mixtures thereof. Moreover, as indicated above, the exfoliant may consist of insoluble fibres included in the sheet of fibres of the support.

The exfoliating particles may be present in an amount ranging, for example, from 0.5 to 40% by weight, preferably from 1 to 20% by weight, and better still from 1 to 10% by weight relative to the total weight of the composition. When the composition contains exfoliating particles, the article obtained may be used in particular for scrubbing facial skin or body skin.

### Additives

The composition of the invention may contain one or more additives, in particular those which are anhydrous or in solid form (powder), chosen from those generally used in the cosmetics and dermatological fields, such as, for example, sequestering agents, fragrances, antioxidants, active agents, preserving agents, dyestuffs (such as hydrophilic pigments and dyes) and inorganic fillers and/or organic fillers such as modified starch, such as that sold under the name Dry Flo by the company National Starch.

The active agents can be chosen in particular from keratolytic agents, moisturizers, antimicrobial agents, vitamins, anti-dandruff or anti-seborrhoeic agents, and agents for hair growth. According to a specific embodiment of the invention, the active agents can be encapsulated or adsorbed onto powders.

As moisturizers, mention may be made of polyols such as glycerol; compounds that act on the barrier function, with a view to maintaining moisturization of the stratum corneum, or occlusive compounds, in particular ceramides, sphingoid-based compounds, lecithins, glycosphingolipids, phospholipids, cholesterol and its derivatives, phytosterols (stigmasterol, β-sitosterol, campesterol), essential fatty acids, 1,2-diacyl-glycerol, 4-chromanone, pentacyclic triterpenes such as ursolic acid, petroleum jelly and lanolin; compounds that directly increase the water content of the stratum corneum, such as threalose and its derivatives, hyaluronic acid and its derivatives, glycerol, pentane-diol, sodium pidolate, serine, xylitol, sodium lactate, poly(glycerol acrylate), ectoin and its derivatives, chitosan, oligosaccharides and polysaccharides, cyclic carbonates, N-lauroylpyrrolidonecarboxylic acid, and N-α-benzyl-L-arginine; and mixtures thereof.

As keratolytic agents, mention may be made of β-hydroxy acids, in particular salicylic acid and its derivatives (including 5-n-octanoylsalicylic acid); α-hydroxy acids, such as glycolic acid, citric acid, lactic acid, tartaric acid, malic acid or mandelic acid, and mixtures thereof.

As antimicrobial agents, mention may, for example, be made of 2,4,4′-trichloro-2′-hydroxydiphenyl ether (or triclosan), 3,4,4′-trichlorocarbanilide (or triclocarban), phenoxyethanol, phenoxypropanol, phenoxyisopropanol, hexamidine isethionate, metronidazole and its salts, miconazole and its salts, itraconazole, terconazole, econazole, ketoconazole, saperconazole, fluconazole, clotrimazole, butoconazole, oxiconazole sulphaconazole, sulconazole, terbinafine, ciclopiroxe, ciclopiroxolamine, undecylenic acid and its salts, benzoyl peroxide, 3-hydroxybenzoic acid, 4-hydroxybenzoic acid, phytic acid, N-acetyl-L-cysteine acid, lipoic acid, azelaic acid and its salts, arachidonic acid, resorcinol, octopirox, octoxy-glycerol, octanoylglycine, caprylyl glycol, 10-hydroxy-2-decanoic acid, dichlorophenyl imidazole dioxolane and its derivatives described in patent WO-A-93/18743, farnesol, phytosphingosines, and mixtures thereof.

As anti-dandruff agents, mention may, for example, be made of pyridinethione salts, in particular calcium salts, magnesium salts, barium salts, strontium salts, zinc salts, cadmium salts, tin salts and zirconium salts; 1-hydroxy-2-pyrrolidone derivatives; 2,2′-dithiobis(pyridine-N-oxide); trihalocarbamides; triclosan; nitrogenous compounds such as climbazole, ketoconazole, clotrinazole, econazole, isoconazole and miconazole; antifungal polymers such as amphotericin B or nystatin; selenium sulphide; sulphur in its various forms; cadmium sulphide; allantoin; coal tar or wood tar and their derivatives, in particular oil of cade; salicylic acid; undecylenic acid; fumaric acid; allylamines such as terbinafine.

As agents for hair growth, mention may in particular be made of 2,4-diamino-6-piperidinopyrimidine 3-oxide or “minoxidil” described in patents U.S. Pat. No. 4,139,619 and U.S. Pat. No. 4,596,812, or else its numerous derivatives, such as those described, for example, in patent applications EP-A-0353123, EP-A-0356271, EP-A-0408442, EP-A-0522964, EP-A-0420707, EP-A-0459890 and EP-A-0519819.

Vitamins that may be used include water-soluble or liposoluble vitamins or provitamins, such as, for example, vitamin A (retinol), vitamin C (ascorbic acid), vitamin B3 or PP (niacinamide), vitamin B5 (panthenol), vitamin B6 or pyridoxine, vitamin E (tocopherol), vitamin K1, beta-carotene, and the derivatives of these vitamins, and in particular esters thereof, and mixtures thereof.

The composition may also contain lipophilic compounds, for example oils such as liquid petroleum jelly, and silicone compounds, provided that they do not disturb the foam formation. The lipophilic compounds are generally in an amount of less than 10% by weight relative to the total weight of the composition.

Of course, those skilled in the art would take care to choose this or these possible additive(s) and/or the amount(s) thereof in such a way that the advantageous properties intrinsically associated with the composition in accordance with the invention are not, or not substantially, impaired by the addition(s) envisaged.

The The article according to the invention may in particular constitute a cleansing product for the skin (of the face and/or of the body) or the hair (shampoo), and an exfoliating product for the skin (of the face and/or of the body).

The examples which follow serve to illustrate the invention without, however, being limiting in nature. The amounts are indicated as % by weight unless otherwise mentioned, and they correspond, unless otherwise mentioned, to the amount of starting material and not to the amount of active material. The names of the compounds used are given as the CTFA name, as the chemical name or as the trade name.

### EXAMPLES

The article used in the examples was prepared with a support made of PVA-based Kuralon K-II WN2 fibres, which fibres are soluble at a temperature less than or equal to 20° C. It was obtained by heat-sealing, at their periphery, two layers having a weight of 80 g/m².

The article was in the form of a disc 3 cm in diameter, comprising a cavity into which was introduced the composition containing the surfactant in an amount of 0.3 g.

### Example 1 According to the Invention and Comparative Examples 1 to 3

| Composition carried | Example 1 according to | Comparative | Comparative | Comparative |
|---|---|---|---|---|
| by the support | the invention | Example 1 | Example 2 | Example 3 |
| Sodium lauroyl | 100 | — | — | — |
| glutamate (1) | | | | |
| Sodium cocoyl | — | 50 | — | — |
| isethionate (2) | | | | |
| Potassium myristate | — | 50 | — | — |
| Lauryl sulphate (3) | — | — | 100 | — |
| Cocamido propyl | — | — | — | 100 |
| betaine (4) | | | | |

Evaluation of the product

| | | | | |
|---|---|---|---|---|
| Mixing in water | Rapid solubilization of | Solubilization of | Poor | Agglomeration of |
| | the article, giving a | the article quite | solubilization | the powder, |
| | white milk | rapid; but product | and sticky, very | forming grains |
| | | obtained very | slimy paste | that solubilize |
| | | thick and very | obtained | slowly in water |
| | | tacky | | |

Foam quality

| | | | | |
|---|---|---|---|---|
| Volume | 6.8 | 5.3 | 8.5 | 7 |
| Bubble size | 3 | 0.8 | 7.3 | 5 |
| Density | 7.5 | 7 | 6.8 | 6.5 |

(1) Amisoft LS 11 (Ajinomoto)
(2) Jordapon CIP (BASF)
(3) Tensopol USP97 (Tensachem)
(4) Tego Bétain CKD (Degussa)

When the article is used, it is rapidly run under water, and is then placed in the hollow of the hand for a few seconds and massaged so as to develop the foam, adding water in small amounts, if necessary, so as to increase the foam volume. Next, the foam obtained is applied to the face, which may or may not have been moistened beforehand, and the skin is cleansed by massaging, and is then rinsed with clear water and dried.

The foaming properties of the article of the example according to the invention were evaluated by means of an evaluation test.

Evaluation test: it was carried out according to the following protocol:

The hands are washed 3 times with household soap and carefully rinsed. Excess water is removed by shaking the hands 3 times.

The article is placed in the hollow of one of the hands.

The foam is formed by adding 2 ml of water to the hollow of the hand and by shearing the product for 10 seconds by sliding one hand over the other (approximately 20-30 movements back and forwards), and then by adding a further 2 ml of water and again shearing the product for 10 seconds.

At the end of this protocol, the foam was evaluated according to 3 criteria:
foam volume (high score=large volume)
bubble size (high score=coarse foam, the lower the score, the smaller the size of the bubbles)
foam density (high score=foam more elastic, non-runny).

The results given in the table above show that the example according to the invention gives a product that offers good mixing in water and a very good foam quality, whereas the comparative examples containing surfactants other than those claimed, produce products that do not mix as well in water and/or provide foams of poorer quality.

Examples 2 to 6 according to the invention:

| | Example 2 | Example 3 | Example 4 | Example 5 | Example 6 |
|---|---|---|---|---|---|
| Composition carried by | according to | according to | according to | according to | according to |
| the support | the invention | the invention | the invention | the invention | the invention |
| Sodium lauroyl | 50 | — | — | 75 | — |
| glutamate (1) | | | | | |
| Monosodium myristoyl | — | 50 | 65 | | — |
| glutamate (2) | | | | | |
| Sodium cocoyl glycinate (3) | — | 50 | — | | 86 |
| Disodium cocamido mea- | — | — | 30 | | — |
| sulphosuccinate (4) | | | | | |
| Cocamidopropyl betaine (5) | 50 | — | — | 20 | — |
| Hydroxypropyl starch | | | 5 | | — |
| phosphate (6) | | | | | |
| Polyethylene powder (7) | | | | 5 | |
| Modified starch (8) | — | | | | 3.5 |
| Liquid petroleum jelly | — | | | | 10.5 |

(1) Amisoft LS 11 (Ajinomoto)
(2) Acylglutamate MS 11 (Ajinomoto)
(3) Amilite GCS-11(F) (Ajinomoto)
(4) Mackanate CM 100 (MacIntyre)
(5) Tego Betain CKD (Degussa)
(6) Structure XL (National Starch)
(7) Microthene MN 727 (Equistar)
(8) C* Flo 06205 (Cerestar)

It was found that Examples 2 to 6 above mixed well in water and gave good foaming properties.

The above written description of the invention provides a manner and process of making and using it such that any person skilled in this art is enabled to make and use the same, this enablement being provided in particular for the subject matter of the appended claims, which make up a part of the original description and including an article, in particular a cosmetic or dermatological article, especially for topical application, comprising a support in the form of at least one sheet comprising fibres that are water-soluble at a temperature less than or equal to 30° C., and a composition carried by the support, comprising at least one foaming surfactant chosen from acylamino acids and derivatives thereof.

As used herein, the phrases “selected from the group consisting of,” “chosen from,” and the like include mixtures of the specified materials. Terms such as “contain(s)” and the like as used herein are open terms meaning ‘including at least’ unless otherwise specifically noted.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. An article, comprising:
a support in the form of at least one sheet comprising fibres that are water-soluble at a temperature of 0-30° C., and
a composition carried by the support, comprising at least one foaming surfactant chosen from acylamino acid compounds.

2. The article according to claim 1, wherein the fibres that are water-soluble are prepared with polyvinyl alcohol.

3. The article according to claim 1, wherein at least one sheet comprising fibres is a nonwoven.

4. The article according to claim 1, wherein the at least one sheet comprising fibres that are water-soluble further comprises water-insoluble fibres.

5. The article according to claim 4, wherein the amount of water-insoluble fibres is at most 40% by weight relative to the total weight of the fibres.

6. The article according to claim 1, wherein the support comprises at least two sheets, at least one of which comprises fibres that are water-soluble at a temperature of 0-30° C.

7. The article according to claim 1, comprising:
a support in the form of at least two sheets that together define one or more cavities, at least one of the sheets comprising fibres that are water-soluble at a temperature of 0-30° C.,
at least one of the cavities comprising the composition containing at least one foaming surfactant chosen from acylamino acid compounds.

8. The article according to claim 7, wherein at least two of the sheets of fibres are nonwovens.

9. The article according to claim 7, wherein one of the sheets is a nonwoven consisting of fibres that are water-soluble at a temperature of 0-30° C., and another of the sheets is a nonwoven consisting of water-insoluble fibres.

10. The article according to claim 7, wherein the at least two sheets are assembled at their periphery.

11. The article according to claim 10, wherein the sheets are heat-sealed.

12. The article according claim 7, wherein the support is entirely water-soluble.

13. The article according to claim 1, wherein the amount of acylamino acid compound surfactant(s) represents from 2 to 100% of the total weight of the composition carried by the support.

14. The article according to claim 1, wherein the acylamino acid compounds are chosen from acylalaninate salts, acylglutamate salts, acylaspartate salts, acylglycinate salts and acylsarcosinate salts, and mixtures thereof.

15. The article according to claim 1, wherein the acylamino acid compounds or the composition containing them is/are in pulverulent or pasty form.

16. The article according to claim 1, wherein the composition further comprises one or more foaming surfactants other than acylamino acid compounds.

17. The article according to claim 1, wherein the composition carried by the support represents from 10 to 1000% by weight relative to the weight of the support.

18. The article according to claim 1, wherein it constitutes a cleansing product for the skin and/or the hair or an exfoliating product for the skin.

19. The article according claim 1, wherein the support is entirely water-soluble.

20. A composition obtained by dissolving the article according to claim 1 in water.

21. A process for cleansing a keratin material, comprising:
the formation of a cosmetic composition by dissolving, in water, a support in the form of at least one sheet comprising fibres that are water-soluble at a temperature of 0-30° C. and a composition carried by the support comprising at least one foaming surfactant chosen from acylamino acid compounds to form a resultant composition; and
applying the resultant composition to the keratin material.

22. A kit comprising:
a packaging,
at least one article, comprising:
a support in the form of at least one sheet comprising fibres that are water-soluble at a temperature of 0-30° C., and
a composition carried by the support, comprising at least one foaming surfactant chosen from acylamino acid compounds.
